(19) United States
(12) Patent Application Publication
(10) Pub. No.: US 2003/0133768 A1
(43) Pub. Date: Jul. 17, 2003

(54) Fastener assembly having grooves for use with a power actuated gun

(76) Inventor: Alfonso Losada, Bridgeport, CT (US)

Correspondence Address: Paul A. Fattibene, Fattibene and Fattibene, 2480 Post Road, Southport, CT, 06490, US

(21) Appl. No.: 10/043,669

(22) Filed: Jan. 11, 2002

(51) Int. Cl. F16B 39/00

(52) U.S. Cl. 411/107

(57) ABSTRACT

A fastener assembly for use with a power actuated gun having a plurality of extending portions or grooves extending from a bearing surface. The extending portion or grooves extending from a bearing leg of a power actuated fastener aid in preventing rotation of the fastener assembly. Additionally, in another embodiment utilizing a raised portion, the raised portion aids in the collapse of the raised portion so as to permit the fastener assembly to form a more complete contact with a substrate. In another embodiment of the present invention, the extending portions or grooves are utilized to aid the feeding of a plurality of loose fastener assemblies in a track of a power actuated gun feeding system. The present invention provides an improved fastener assembly for use in construction.

### FIELD OF THE INVENTION

The present invention relates in general to a fastener used with a power actuated gun, and in particular to a fastener assembly having enhanced properties.

### BACKGROUND OF THE INVENTION

There are many different types of fastener assemblies for use with a power actuated gun that contain a bracket or a plate in combination with a nail or a stud. These fastener assemblies are used for a variety of purposes, such as attaching various substrates or for making connections with other construction materials. One such fastener assembly is disclosed in U.S. Pat. No. 4,736,923 entitled “Fastener Assembly” issuing to Losada on Apr. 12, 1988, which is herein incorporated by reference. Therein disclosed is a fastener assembly having a leg portion that is angularly offset in a nail or stud for driving into a support structure with a power actuated gun. Another fastener assembly is disclosed in U.S. Pat. No. 5,634,756 entitled “Fastener Assembly For Use With Power Actuated Gun” issuing to Losada on Jun. 3, 1997, which is herein incorporated by reference. Therein disclosed is a fastener assembly for use with a power actuated gun that has a relatively broad bearing surface and raised portions of different configurations for holding a stud or a nail. This fastener assembly is used to drive a fastener for holding a structure being fastened into a hard substrate, such as masonry.

While these prior fasteners have served the construction industry well, they are not without problems. In many situations, the fasteners may not lay flush on the substrate or may be prone to rotation about the nail or the stud. This is undesirable, particularly when an attachment is made to the fastener, such as a wire, which may then become loose or move. Additionally, for a variety of reasons if a raised portion is utilized on the fastener assembly, the raised portion may not collapse sufficiently so as to contact the substrate. Therefore, there is a need in the power actuated fastener assembly art to provide a fastener that is not susceptible to rotation or a fastener that has a raised portion that can readily and easily collapse contacting a substrate.

### SUMMARY OF THE INVENTION

The present invention comprises a fastener assembly for use with a power actuated gun in securing the fastener assembly to a substrate so that rotation and incomplete collapsing of the fastener assembly is prevented. The fastener assembly comprises a plate having an extending portion or a groove extending from the surface thereof. A nail extends through the plate for driving with a power actuated gun. In one embodiment having a raised portion, the grooves are placed along the raised portion and aid in assistng the raised portion to collapse fully when the nail or stud is driven by a power actuated gun.

Accordingly, it is an object of the present invention to provide an improved fastener assembly.

It is another object of the present invention to provide a fastener assembly that may be more securely attached to a substrate.

It is an advantage of the present invention that turning or rotation of the fastener assembly is prevented.

It is a further advantage of the present invention that the fastener assembly having a raised portion may be more easily be collapsed adjacent to a substrate.

It is yet another feature of the present invention that it may be utilized to improve alignment in a track used to feed a plurality of fastener assemblies.

It is a feature of the present invention that an extending portion extends from a surface of the fastener assembly to contact a substrate.

It is another feature of the present invention that a groove is placed within a raised portion of a fastener assembly to facilitate collapsing of he raised portion.

These and other objects, advantages, and features will become readily apparent in view of the following detailed description.

### BRIEF DESCRIPTION OF THE DRAWINGS

FIG. 1A is a perspective view of a fastener assembly.

FIG. 1B is an elevational view of the fastener assembly illustrated in FIG. 1A.

FIG. 2 is a perspective view of another fastener assembly.

FIG. 3 is a perspective view of yet another fastener assembly.

FIG. 4 is a perspective view of still another fastener assembly.

FIG. 5A is a perspective view of an embodiment of the present invention utilized for assisting alignment of a fastener assembly in a track.

FIG. 5B is a partial cross-section of the embodiment illustrated in FIG. 5A positioned within a track.

FIG. 6 is a perspective view of another embodiment of the present invention having a raised portion.

FIG. 7 is a perspective view of yet another embodiment of the present invention having a raised portion.

FIG. 8 is a perspective view of another embodiment of the present invention in the form of a round washer.

FIG. 9A is a perspective view of yet another embodiment of the present invention.

FIG. 9B is a side elevational view of the embodiment illustrated in FIG. 9A.

FIG. 9C is a cross-section taken along line 9C-9C in FIG. 9B.

FIG. 10A is a perspective view of yet another embodiment of the present invention.

FIG. 10B is a cross-section taken along line 10B-10B in FIG. 10A.

### DETAILED DESCRIPTION OF THE PREFERRED EMBODIMENTS

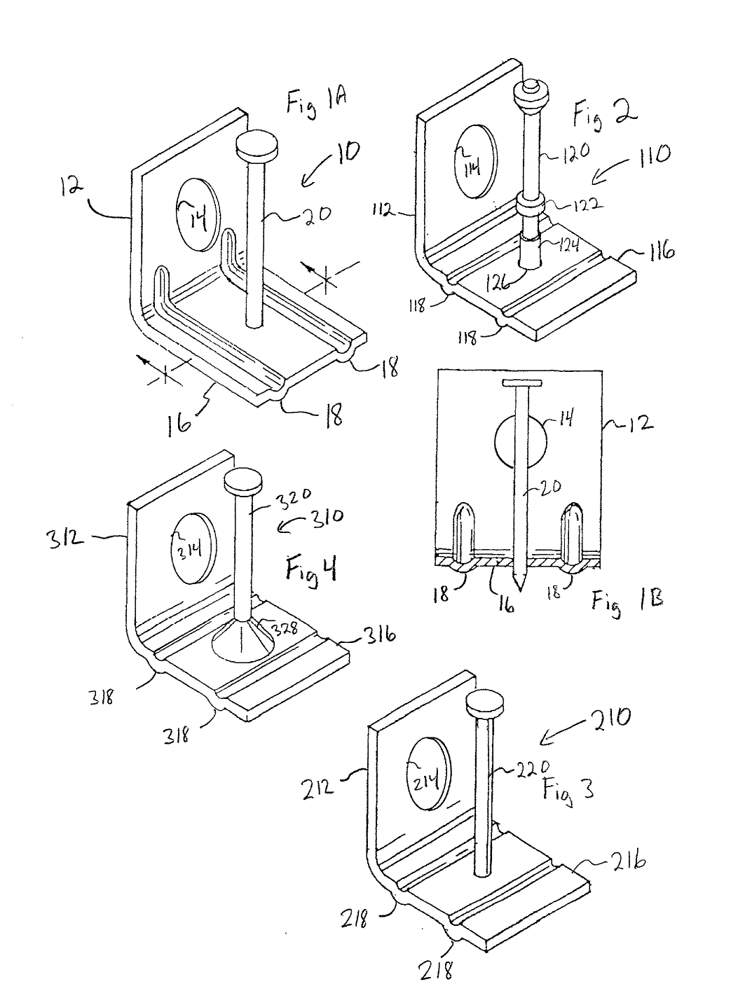

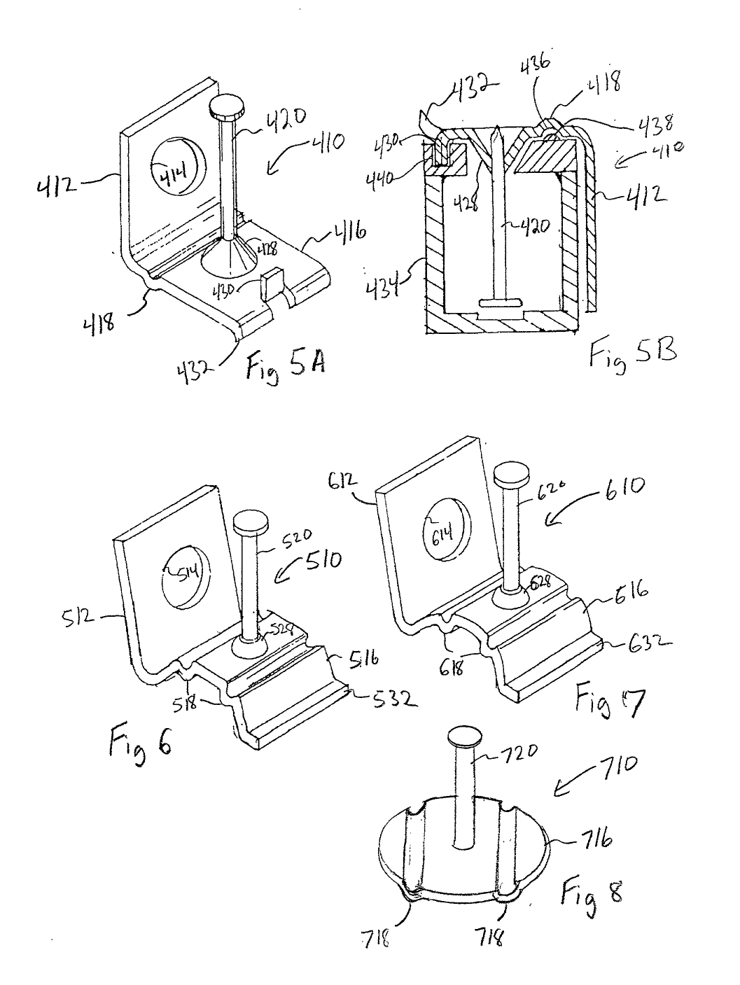

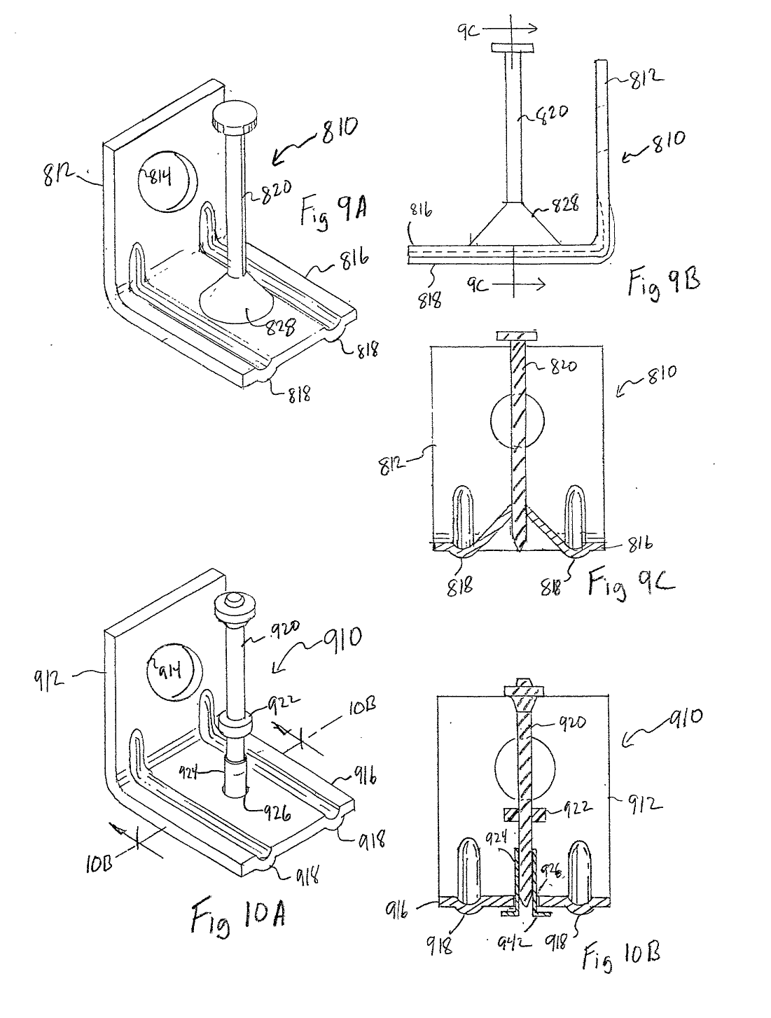

FIG. 1A is a perspective view illustrating an embodiment of the present invention. In FIG. 1A, a fastener assembly comprises an attachment leg 12 having a hole 14 therein. A bearing leg 16 is angularly attached to the attachment leg 12. The bearing leg 16 and the attachment leg 12 are formed from a metal plate. Formed within the bearing leg 16 are extending portions 18. The extending portions 18 may form a groove within the bearing leg 16. Bearing leg 16 is substantially planar or flat and has a stud 20 frictionally held therein. Upon driving the nail or stud 20 with a power actuated gun into a substrate, the bearing leg 16 is held into contact with the substrate and the extending portions 18 aid in preventing the fastener assembly 10 from rotating about the nail or stud 20. Often, a wire or other attachment is placed through the hole 14 in the attachment leg 12 for holding another member, such as a suspended ceiling, in place. It is undesirable for the fastener assembly 10 to rotate. Should the fastener assembly rotate misalignment could occur. Should the fastener assembly 10 rotate and misalignment occur, an adjustment might be required. A misalignment is particularly troublesome when the fastener assembly 10 is used to suspend a ceiling. In suspending a ceiling, one end of a wire is usually attached to the hole 14 in the attachment leg 12, and the other end of the wire attached to a frame for the suspended ceiling. If there is any rotation of the fastener assembly 10 after installation, the length of the wire will change, and the suspended ceiling will no longer be flat. Costly and time-consuming readjustments of the wire will be needed should the fastener assembly 10 rotate.

FIG. 1B is an elevational view of the embodiment illustrated in FIG. 1A, and more clearly illustrates the extending portions 18. The extending portions 18 may be in the form of a groove and may be formed in the fastener assembly by a pressing and deforming action. The extending portions 18 need not be a groove but may simply extend from the surface of the bearing leg 16 of the fastener assembly 10. FIGS. 1A and 1B illustrate the extending portions 18 extending perpendicular to the plane of the attachment leg 12.

FIG. 2 illustrates another embodiment of the present invention. In this embodiment, the extending portions 118 extend parallel to the plane of the attachment leg 112. In the fastener assembly 110, illustrated in FIG. 2, a leg attachment 112 is angularly attached to a bearing leg 116. Bearing leg 116 has extending portions or grooves 118 formed therein. The extending portions or grooves 118 extend the length of the bearing leg 116 and are in a direction parallel to the plane of the attachment leg 112. A nail or stud 120 has a ring 122 thereon. The ring 122 may be made of any plastic type material and is used to hold and guide the fastener assembly 110 within a barrel of a power actuated gun, not shown. In this embodiment, the stud or nail 120 is held within the bearing leg 116 with an attached retainer 124 that is placed through a hole 126 and has a flange, not shown, on the other end which is larger than the diameter of the hole 126. In this embodiment, the nail or stud 120 is loosely held within the fastener assembly 110, yet is retained by the flange formed on retainer 124 and the ring 122.

FIG. 3 illustrates yet another embodiment of the present invention. In this embodiment, the nail or stud 220 is frictionally retained within the bearing leg 216. The fastener assembly 210, illustrated in FIG. 3, comprises an attachment leg 212 having a hole 214 therein. The attachment leg 212 is angularly attached to a bearing leg 216. Bearing leg 216 has a plurality of extending portions 218 therein. The stud 220 is frictionally retained within a hole placed in the bearing leg 216. The extending portions 218 are substantially parallel with the plane of the attachment leg 212.

FIG. 4 illustrates yet another embodiment of the present invention. In the embodiment illustrated in FIG. 4, a cone 328 is used on the bearing leg 316 so as to hold the stud 320. In this embodiment, the end of the stud 320 may be retained above the substantially planar surface of the bearing leg 316. However, the end of the nail or stud 320 may also extend below the substantially planar surface of bearing leg 316. Additionally, the cone 328 may act as a guide for centering the nail or stud 320 within a barrel of a power actuated gun, as well as permit the substantially planar surface of the bearing leg 316 to rest flatly on a substrate prior to being driven by a power actuated fastener. The fastener assembly 310, illustrated in FIG. 4, comprises an attachment leg 312 having a hole 314 therein angularly attached to a bearing leg 316. The bearing leg 316 has a plurality of extending portions 318 therein. Extending portions 318 extend in a direction substantially parallel to the plane of the attachment leg 312. A cone 328 is formed within the substantially planar surface of the bearing leg 316 and frictionally holds the stud or nail 320 therein.

FIGS. 5A and 5B illustrate an embodiment of the present invention that may be utilized in a track of a fastener feeding system for a power actuated gun. One type of track is disclosed in U.S. Pat. No. 6,273,316 entitled “Fastener Feeding System For Power Actuated Gun” issuing to Losada on Aug. 14, 2001, which is herein incorporated by reference. FIG. 5A illustrates a fastener assembly 410 having an attachment leg 412 with a hole 414 therein. A bearing leg 416 is angularly attached to the attachment leg 412 and has an extending portion or groove 418 therein. The substantially planar bearing leg 416 has a foot 432 and an oppositely extending tab 430 formed therein along one edge. The stud or nail 420 is held within a cone 428 formed in the substantially planar surface of the bearing leg 416. In this embodiment, the extending portion or groove 418 in combination with the tab 430 aid in guiding a plurality of fastener assemblies 410 within a track utilized for feeding a fastener assemblies for driving by a power actuated gun.

FIG. 5B is a partial cross-section of the fastener assembly 410 placed within a track for feeding fastener assemblies 410 for use with a power actuated gun. The track portion 434 guides the fastener assembly 410 by guide means Comprising a mating portion 438 and a groove or channel 440. The mating portion 438 extends from a surface of the track 434 and compliments or mates with the groove 436 formed by the extending portion 418 formed in the fastener assembly 410. The channel 440 holds one edge of the fastener assembly 410 having the tab 430 formed therein. This combination of the track 434 structure and the complimentary or mating portions on the fastener assembly 410 aids in guiding the fastener assembly 410 along the track 434. It should be appreciated that while the tab 430 and channel 440 are illustrated and provide positive guiding means, a second mating portion such as mating portion 438 may be utilized for guiding a fastener assembly such as the embodiments of the present invention utilizing the plurality of extending or raised portions like those illustrated in FIGS. 2-4. Accordingly, it should be appreciated that the guiding means of the present invention may be utilized as long as the cross-section of the fastener assembly mates with a portion of a track assembly. Therefore, the extending portion 418 on the fastener assembly 410 may also extend in the opposite direction. This prevents the fastener assembly from twisting and jamming within a track utilized for feeding a plurality of unattached fastener assemblies.

FIG. 6 illustrates another embodiment of the present invention having a raise bearing leg 516 that has a rectangular cross-section The embodiment illustrated in FIG. 6 comprises a fastener assembly 510 having an attachment leg 512 with a hole 514 therein. Angularly attached to the attachment leg 512 is a bearing leg 516. The bearing leg 516 has a raised portion and extending portions or grooves 518 formed therein. The extending portion or grooves are preferably placed at the corners of the raised bearing leg 516. A foot 532 may be formed along one edge of the bearing leg 516. A stud 520 is frictionally retained within a cone 528 formed within the bearing leg 516.

FIG. 7 illustrates another embodiment of the present invention having a raised bearing leg 616. The fastener assembly 610, illustrated in FIG. 7, comprises an attachment leg 612 having a hole 614 therein. Angularly attached to the attachment leg 612 is a bearing leg 616. The bearing leg 616 forms a substantially continuous curve or a portion of a cylinder with a raised central portion. On a top surface of the raised central portion is a cone 628 frictionally holding a stud 620 therein. Extending portions or grooves 618 are formed within the bearing leg 616. A foot 632 may be formed along one edge of the bearing leg 616.

The embodiments illustrated in FIGS. 6 and 7 having the extending portions or grooves 518 and 618 may be utilized in a complimentary mating portion of a track to guide the fastener assembly 510 and 610 longitudinally along the track. Additionally, the extending portions or grooves 518 and 618 aid in helping the raised bearing leg 516 and 616 to collapse when the stud or nail 520 and 620 are driven by a power actuated gun. Accordingly, the bearing leg 516 and 616 may readily collapse and contact a substrate more completely. Additionally, the extending portions 518 and 618 provide a bearing surface, which may extend into the substrate slightly and prevents rotation of the fastener assembly 510 and 610 about the nail or stud 520 and 620.

Additionally, the embodiments illustrated in FIGS. 6 and 7 permit the stud or nail 520 and 620 to be frictionally retained within the bearing legs 516 and 616 and yet have a substantial portion of the pointed end or stud 520 retained above the plane formed by the bearing leg 516 and 616 contacting a substrate. Accordingly, the fastener assemblies 510 and 610 can lie substantially flat on a substrate. However, the pointed end of the nail 520 and 620 may extend below the planar surface formed by initially bearing surfaces of the bearing leg 516 and 616.

FIG. 8 illustrates yet another embodiment of the present invention utilizing a flat, round washer. In FIG. 8, a fastener assembly 710 comprises a substantially flat round washer 716 having a hole and a stud 720 frictionally retained therein. Formed within the substantially planar surface of the flat washer 716 are extending portions or grooves 718. The two extending portions or grooves 718 are in preventing rotation of the round washer 716. The grooves 718 also have the advantage that when the fastener assembly is used to attach wood or other equivalent material, the grooves 718 prevent the wood from splitting or cracking as the nail or stud 720 is driven through the wood.

FIGS. 9A-C illustrate yet another embodiment of the present invention. In this embodiment, a fastener assembly 810 has an attachment leg 812 having a hole 814 therein. Angularly attached to the attachment leg 812 is a bearing leg 816. The bearing leg 816 has a plurality of extending portions or grooves 818 formed therein. The extending portions or grooves 818 extend substantially perpendicular to the plane of the attachment leg 812. A cone 828 is formed within the surface of bearing leg 816. A stud or nail 820 is frictionally retained within the cone 828.

FIGS. 10A and 10B illustrate yet another embodiment of the present invention. In this embodiment, the nail 920 is loosely held within the bearing leg 916. The fastener assembly 910 comprises an attachment leg 912 having a hole 914 therein. Angularly attached to the attachment leg 912 is the bearing leg 916. Within bearing leg 916 is a plurality of extending portions or grooves 918. The extending portions or grooves 918 extend substantially perpendicular to the plane of the attachment leg 912. Placed within the bearing leg 916 is a hole 926. Frictionally attached to a pointed end of the stud or nail 920 and held within the hole 926 is a retainer 924. The retainer 924 has a flange 942 thereon. The nail or stud 920 is held within hole 926 by the co-action of the ring 922 and the flange 942.

Accordingly, it should be appreciated that all of the embodiments of the present invention provide a fastener assembly that has an extending portion or groove formed in a bearing leg surface that aids in preventing the fastener assembly from rotating after being driven into a substrate. Additionally, in another embodiment of the present invention, the extending portions or grooves are formed in a raised portion of the bearing leg and aid in the collapse of the bearing leg raised portion so as to come into contact with a substrate upon the fastener assembly being driven by a power actuated gun. Subsequent to the extending portion or grooves aiding in the collapse of the raised portion, the extending portion or grooves help prevent rotation of the fastener assembly. Additionally, while many of the embodiments have been illustrated with an attachment leg angularly attached thereto, the present invention may be utilized without any such attachment leg. The present invention, with its extending portions or grooves, is particularly well suited for use in aiding the guiding of a plurality of fastener assemblies longitudinally along a track utilized for feeding a plurality of fastener assemblies in a power actuated gun.

While the present invention has been described with respect to several embodiments, it should be appreciated that various modifications may be made without departing from the spirit and scope of this invention.

What is claimed is:

1. A fastener assembly comprising:
a plate having a bearing surface;
a stud held within said plate; and
an extending portion extending from the bearing surface.

2. A fastener assembly as in claim 1 wherein:
said extending portion comprises a groove.

3. A fastener assembly as in claim 1 further comprising:
an attachment leg angularly attached to said plate.

4. A fastener assembly as in claim 3 wherein:
said extending portion extends parallel to a plane of said attachment leg.

5. A fastener assembly as in claim 1 wherein:
said plate comprises a raised portion.

6. A fastener assembly as in claim 1 further comprising:
a cone formed on said plate, said cone holding said stud.

7. A fastener assembly as in claim 5 wherein:
said stud does not extend bellow the bearing surface.

8. A fastener assembly as in claim 5 wherein:
said stud extends bellow the bearing surface.

9. A fastener assembly as in claim 1 further comprising:
guide means, formed in said plate, for guiding the fastener assembly in a track.

10. A fastener assembly as in claim 5 further comprising:
means, formed in said plate, for assisting collapse of the raised portion.

11. A fastener assembly comprising:
a plate having a bearing surface;
a stud held within said plate; and
guide means, placed on said plate, for guiding the fastener assembly within a track.

12. A fastener assembly as in claim 11 wherein:
said guide means comprises a groove.

13. A fastener assembly as in claim 11 wherein:
said guide means comprises a tab.

14. A fastener assembly as in claim 11 further comprising:
a raised portion formed in said plate.

15. A fastener assembly as in claim 12 further comprising:
an attachment leg angularly attached to said plate, and
said groove extends parallel to a plane of said attachment leg.

16. A fastener assembly comprising:
a plate having a raised portion;
a stud held within said plate; and
a plurality of grooves formed within the raised portion of said plate,
whereby said plurality of grooves assists the raised portion to collapse when the fastener assembly is driven by a power actuated gun.

17. A fastener assembly as in claim 16 wherein:
the raised portion of said plate has a substantially rectangular cross section.

18. A fastener assembly as in claim 17 wherein:
one of said plurality of grooves is placed at each corner of said rectangular cross section.

19. A fastener assembly as in claim 16 wherein:
the raised portion of said plate comprises a portion of a cylinder.

20. A fastener assembly feeding system for use with a power actuated gun comprising:
a plate;
a stud held within said plate;
an extending portion formed on said plate;
a feeding track; and
a mating portion formed on said track, said mating portion complementing said extending portion,
whereby the fastener is guided along said feeding track.

21. A faster feeding system for use with a power actuated gun as in claim 20 wherein:
said extending portion comprises a groove.

22. A faster feeding system for use with a power actuated gun as in claim 20 further comprising:
an attachment leg angularly attached to said plate.

23. A faster feeding system for use with a power actuated gun as in claim 20:
wherein said plate has a raised portion.

24. A fastener assembly feeding system for use with a power actuated gun comprising:
a plate having a bearing leg with a raised portion and an attachment leg;
a stud frictionally held within the raised portion of said bearing leg;
a groove placed within said bearing leg between said stud and said attachment leg, said groove extending parallel to a plane of the attachment leg;
a foot formed on one edge of said bearing leg;
a tab formed in said bearing leg and extending in a direction opposite to said foot;
a track portion adapted to receive said plate;
a mating portion formed in said track portion, said mating portion complementing and adapted to receive said groove; and
a channel formed within said track portion, said channel adapted to receive said tab,
whereby a plurality of fastener assemblies are guided along said track.
